(19) United States
(12) Patent Application Publication
(10) Pub. No.: US 2011/0001895 A1
(43) Pub. Date: Jan. 6, 2011

(54) DRIVING MECHANISM FOR LIQUID CRYSTAL BASED OPTICAL DEVICE

(76) Inventor: Scott R. Dahl, Corning, NY (US)

Correspondence Address: PATTERSON & SHERIDAN, LLP, 3040 POST OAK BLVD, SUITE 1500, HOUSTON, TX, 77056, US

(21) Appl. No.: 12/497,892

(22) Filed: Jul. 6, 2009

(51) Int. Cl. G02F 1/1335

(52) U.S. Cl. 349/18

(57) ABSTRACT

An optical device with liquid crystal (LC) cells for conditioning the polarization of incident light includes a drive unit for the LC cells that employs a digital technique. According to this digital technique, the drive unit generates control signals for opposing electrodes of the LC cells based on digital signals that have the same period but differ in phase by up to one-half period. By employing digital signals that differ in phase by up to one-half period with high resolution, the differential voltage across the LC cells can be controlled precisely to a desired RMS value.

### BACKGROUND OF THE INVENTION

1. Field of the Invention

Embodiments of the present invention relate generally to optical communication systems and components and, more particularly, to a driving mechanism for a liquid crystal-based optical device.

2. Description of the Related Art

Liquid crystal (LC) based optical devices are known in the art, and in some applications, offer significant advantages over other optical device designs. In an LC based optical device, LC cells are used to rotate the polarization of incident light. By controlling the polarization, other optical elements, such as birefringent materials and wave plates, can be employed to direct light according to orthogonal polarization states. U.S. patent application Ser. No. 12/014,730, filed Jan. 15, 2008 and U.S. patent application Ser. No. 12/392,800, filed Feb. 25, 2009, both of which are incorporated by reference herein, describe optical switches that employ LC cells for rotating the polarization of incident light

A twisted nematic is often used as the LC material in LC cells. A twisted nematic LC cell rotates the polarization of light that passes through the cell in response to a voltage that is applied across parallel plates, also referred to as electrodes, enclosing the LC substance. To allow light to pass through the cell, the electrodes are made of transparent material, typically indium tin oxide (ITO). As the voltage across the twisted nematic LC cell is changed, the polarization of light passing through the LC cell rotates by varying amounts, up to an angle of ninety degrees.

The voltage that is applied to the electrodes is generated with a voltage output digital-to-analog converter (DAC) toggling from a positive voltage to a negative voltage with a zero mean. Due to the properties of the interface between the LC material and the adjoining wall, the differential voltage between the two opposite electrodes is required to have a zero mean. The LC substance responds to the root-mean-square (RMS) voltage that is across the LC cell. The frequency of the applied voltage is typically in the kilo-Hertz range. To create the voltage across the LC cell, one side is driven with a square wave with a certain peak-to-peak voltage signal, and the opposite side is driven with another peak-to-peak voltage signal such that the square wave transitions occur at as precisely the same time as possible.

FIGS. 1 and 2 show representative waveforms of this drive technique. X and Y are the voltages applied to electrodes at opposite sides of the LC cell, and the bottom trace, labeled X-Y on the vertical axis, is the differential voltage across the LC cell. When the waveforms of FIG. 1 are used to drive the electrodes, the RMS of the voltage across the LC cell is 1.0 volt. When the waveforms of FIG. 2 are used to drive the electrodes, the RMS of the voltage across the LC cell is 9.0 volts.

With the analog DAC method, each LC cell is driven by an independent DAC. As the number of wavelength channels increases, the cost of an optical device employing the analog DAC method increases correspondingly. For example, for a 50-channel 1×2 wavelength selective switch application, about 50 DAC channels are needed, resulting in the implementation of 50 independent DACs, as well as additional digital processing and logic to drive the DACs, and a printed circuit board and its assembly.

### SUMMARY OF THE INVENTION

Embodiments of the present invention provide an optical device with LC cells that employs a digital technique to drive the LC cells. When compared with the analog DAC method, the digital technique for driving the LC cells allows the optical device to be simpler in design and more scalable, and employ less costly parts to achieve comparable resolution.

An optical device according to an embodiment of the present invention includes a liquid crystal (LC) assembly disposed in optical paths of input beam components and having a plurality of LC cells, each arranged between a pair of opposing control electrodes, and a driving mechanism for the control electrodes. The driving mechanism is configured to generate a first control signal to be applied to the first of the opposing control electrodes from a first digital signal and a second control signal to be applied to the second of the opposing control electrodes from a second digital signal, wherein the first and second digital signals have the same period but differ in phase by up to one-half period.

An optical device according to another embodiment includes a liquid crystal (LC) assembly disposed in optical paths of input beam components, a digital processor for generating digital control signals, a first voltage translator, and a second voltage translator. The LC assembly has a plurality of column electrodes, at least one row electrode, and LC cells arranged between the column electrodes and the at least one row electrode. The first voltage translator is electrically connected to the row electrode for generating a control signal to be applied to the row electrode from a first digital control signal generated by the digital processor and the second voltage translator is electrically connected to a column electrode for generating a control signal to be applied to the column electrode from a second digital control signal generated by the digital processor.

An optical device according to still another embodiment includes a first birefringent displacer disposed in an optical path of an input beam for producing input beam components having first and second orthogonal polarization states, a liquid crystal (LC) assembly disposed in optical paths of the input beam components for conditioning the polarization states of the input beam components, and a second birefringent displacer for directing the input beam components based on their polarization states as conditioned by the LC assembly. The LC assembly has control electrodes and a drive unit that generates control signals for the control electrodes from digital signals that have the same period but differ in phase by up to one-half period.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1 and 2 show representative waveforms generated by an analog drive technique.

FIG. 3 schematically illustrates a cross-sectional view of an optical device having an LC assembly that is driven in accordance with one or more embodiments of the invention.

FIG. 4 illustrates a schematic side view of a birefringent assembly.

FIG. 5 is a block diagram of an LC drive unit used in the optical device of FIG. 3.

FIGS. 6A-D show representative control signals generated by an LC drive unit used in the optical device of FIG. 3.

FIG. 7A is a schematic top view of a wavelength selective switch having an LC assembly that is driven in accordance with one or more embodiments of the invention.

FIG. 7B is a schematic side view of a wavelength selective switch having an LC assembly that is driven in accordance with one or more embodiments of the invention.

FIG. 8 illustrates a schematic cross-sectional view of an LC assembly used in the wavelength selective switch of FIGS. 7A and 7B.

FIGS. 9A-9C are front, side, and rear views of an LC assembly used in an embodiment of a wavelength selective switch having 50 channels.

FIG. 10 is a block diagram of an LC drive unit used to control the LC assembly of FIGS. 9A and 9B.

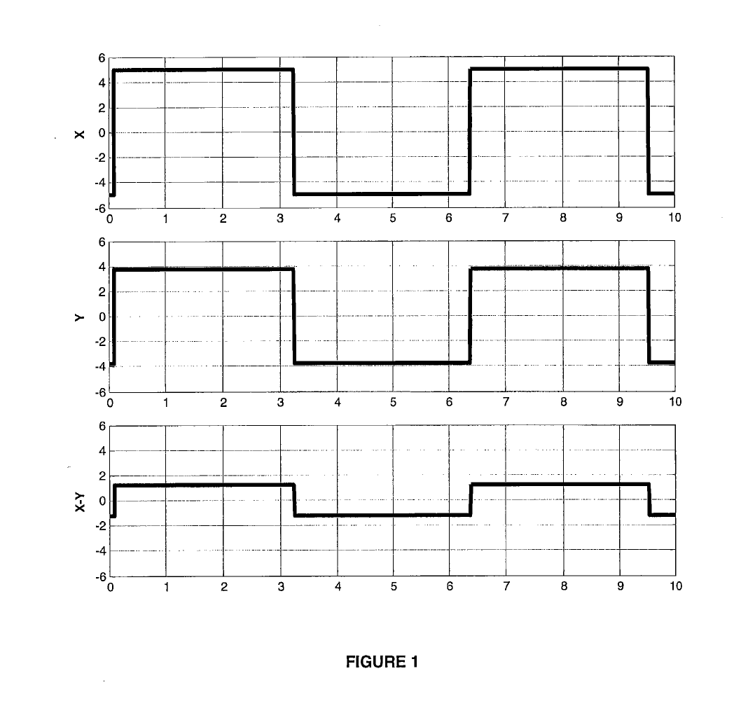

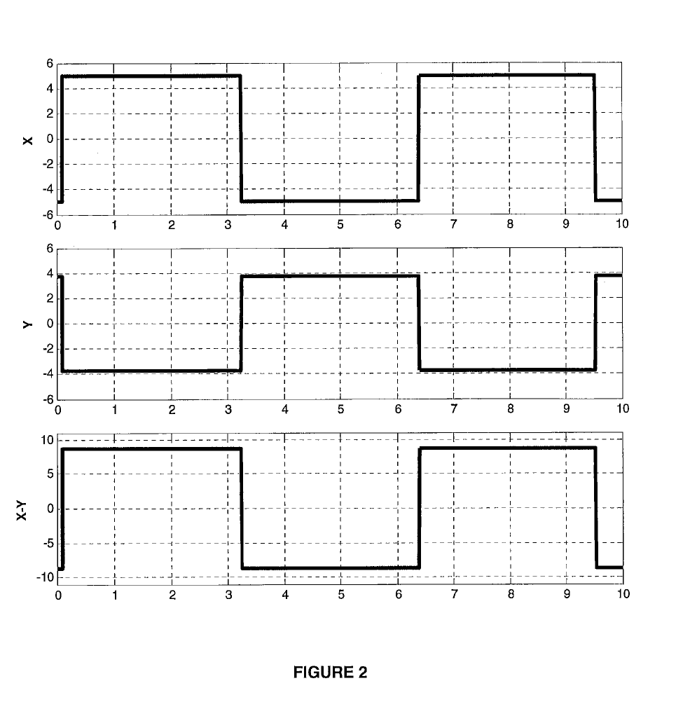

For clarity, identical reference numbers have been used, where applicable, to designate identical elements that are common between figures. It is contemplated that features of one embodiment may be incorporated in other embodiments without further recitation.

### DETAILED DESCRIPTION

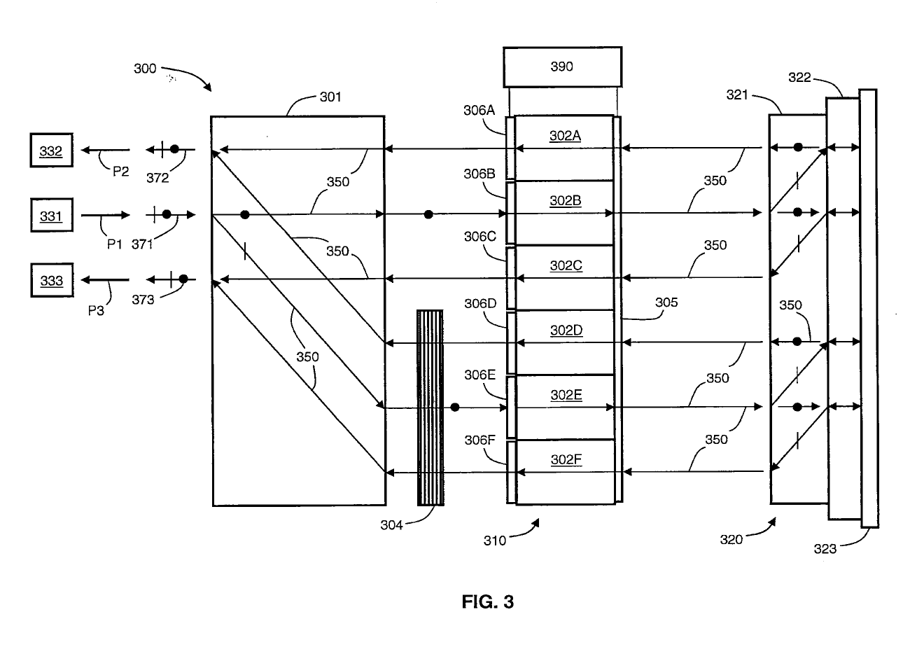

FIG. 3 schematically illustrates a cross-sectional view of an optical device 300 having LC cells that employ a digital technique to drive the LC cells. Optical device 300 includes a birefringent displacer 301, an LC assembly 310, a polarization separating and rotating assembly 320, and a half-wave plate 304, all of which are optically coupled as shown for the treatment, i.e., the switching and attenuation, of an input beam 371. To act as a 1×2 optical switch, optical device 300 is optically coupled to an input port 331 and output ports 332, 333 by optical paths P1, P2, and P3, respectively. The possible optical paths 350 of input beam 371, output beams 372, 373, and their respective s- and p-polarized components in optical device 300 are depicted as arrows. P-polarized light is denoted by a vertical bar, and s-polarized light by a dot.

Birefringent displacer 301 may be a YVO₄ crystal or other birefringent material that translationally deflects incident light beams by different amounts based on orthogonal polarization states. Birefringent displacer 301 is oriented relative to input beam 371 so that light of one polarization state (s-polarization, in the example illustrated in FIG. 3) passes through birefringent displacer 301 without significant deflection and light of the opposite polarization state (p-polarization, in the example illustrated in FIG. 3) passes through birefringent displacer 301 with the deflection shown. Consequently, the s-polarized component of input beam 371 is directed to LC cell 302B for polarization conditioning, and the p-polarized component of input beam 371 is directed to LC cell 302E for polarization conditioning.

LC assembly 310 includes six LC subpixels 302A-F, which contain an LC material, such as twisted nematic (TN) mode material. LC assembly 310 also includes transparent electrodes that apply a potential difference across each of LC subpixels 302A-F. For a twisted nematic mode material, a potential difference of approximately zero volts produces a 90° rotation of polarity and a potential difference of about 5 or more volts produces a 0° rotation of polarity. The transparent electrodes include a single column control electrode 305 and six row control electrodes 306A-F, and may be patterned from indium-tin oxide (ITO) layers. An LC drive unit 390 generates and applies control signals to column control electrode 305 and row control electrodes 306A-F. Because LC subpixels 302C and 302D have the same potential difference applied thereacross in all switching states of optical device 300, subpixels 302C, 302D may be controlled by the same row control electrode. In such an embodiment, the total number of row control electrodes is five.

Polarization separating and rotating assembly 320 includes a birefringent element 321, a quarter-wave plate 322, and a mirror 323. Birefringent element 321 may be substantially similar to birefringent displacer 301, except oriented with an optical axis so that an opposite deflection scheme is realized for incident light relative to the deflection scheme of birefringent displacer 301. Namely, for the example illustrated in FIG. 3, incident p-polarized light passes through birefringent displacer 321 with the deflection shown and s-polarized light passes through birefringent displacer 321 without significant deflection. Quarter-wave plate 322 is mounted on mirror 323, where mirror 323 reflects incident light as shown, and quarter-wave plate 322 rotates the polarization of incident light a total of 90° when incident light passes through quarter-wave plate 322 twice. Alternatively, in lieu of mirror 323, other optical apparatus can be devised by one of skill in the art to redirect light that has passed through LC assembly 310 and quarter-wave plate 322 back toward LC assembly 310 and quarter-wave plate 322 for a second pass.

Half-wave plate 304 is disposed between birefringent displacer 301 and LC assembly 310 and adjacent LC subpixels 302D-F. Being so placed allows half-wave plate 304 to rotate the polarization 90° of light entering and leaving LC subpixels 302D-F. By rotating incident s-polarized light 90° to become p-polarized light and vice-versa with half-wave plate 304, the control scheme for LC cells 302A-C is symmetrical with the control scheme for LC cells 302D-F.

In operation, optical device 300 performs 1×2 switching and attenuation on a linearly polarized input beam in response to a single control signal, where the input beam has an arbitrary combination of s-polarized and p-polarized components. As part of the 1×2 switching operation, optical device 300 can be configured to direct input beam 371 from input port 331 to output port 332 (as output beam 372), or to output port 333 (as output beam 373). 1×2 switching of input beam 371 between output ports 332 and 333 and attenuation of input 371 is accomplished by separating input beam 371 into s- and p-polarized components, conditioning the polarization of each component to a desired polarization using LC assembly 310, directing each component along an optical path based on the conditioned polarization of the component, and recombining the components to form an output beam. One of skill in the art will appreciate that while the example of optical device 300 as described herein is a 1×2 optical switch, optical device 300 is bi-directional in nature and may also operate equally effectively as a 2×1 optical switch. When optical device 300 operates as a 2×1 optical switch, input port 331 acts as the output port and output ports 332, 333 act as the input ports.

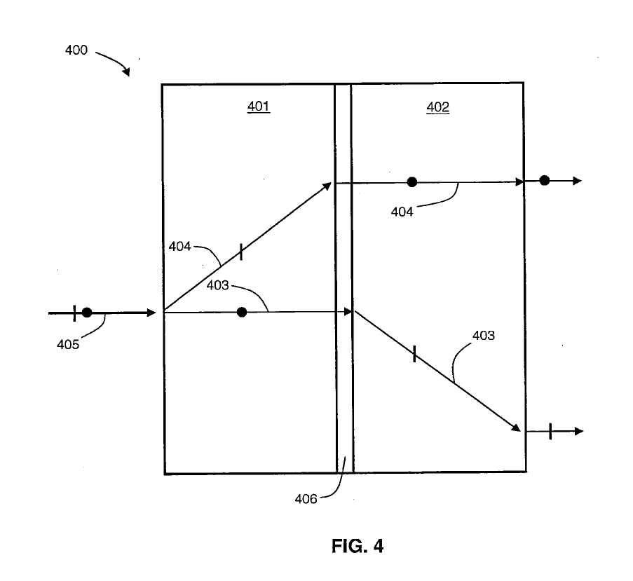

The optical path lengths of components 371A and 371B through birefringent displacer 301 are substantially different, which may produce significant polarization mode dispersion (PMD) and other issues. One of skill in the art will recognize that birefringent displacer 301 in optical device 300 may be replaced with a birefringent assembly that provides equal path lengths for components 371A and 371B. FIG. 4 illustrates a schematic side view of one example of such an assembly. Birefringent assembly 400 includes a first birefringent crystal 401 and a second birefringent crystal 402 that, when configured as shown, provide equal optical path lengths for s-polarized component 403 and p-polarized component 404 of an input beam 405. A half-wave plate 406 is installed between first birefringent crystal 401 and second birefringent crystal 402 to provide a preferred arrangement for s-polarized component 403 and p-polarized component 404.

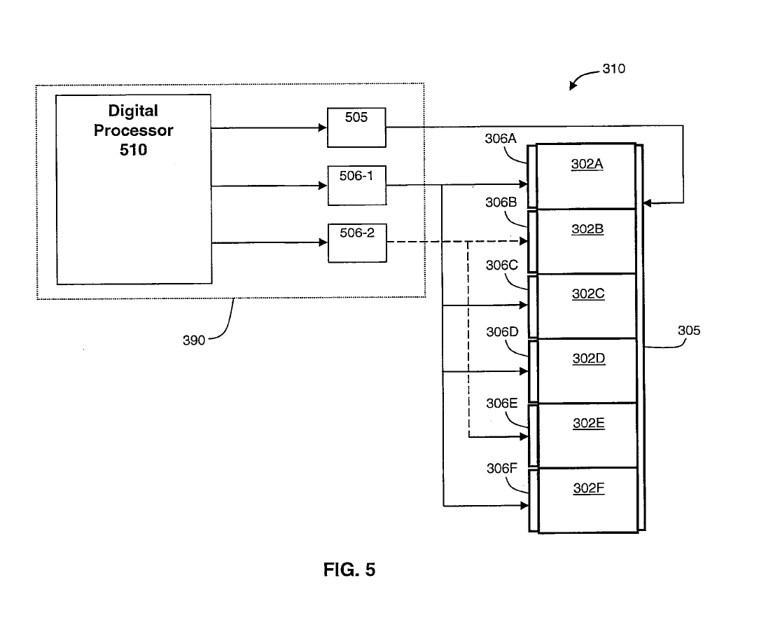

FIG. 5 is a block diagram of LC drive unit 390. LC drive unit 390 includes a digital processor 510 and voltage translators 505, 506-1, 506-2. Digital processor 510 may be a field programmable gate array (FPGA), a complex programmable logic device (CPLD), a digital signal processor (DSP), or any general or special purpose microprocessor including CISC, RISC and ARM types. Alternatively, an FPGA or CPLD can be combined with a processor with a communication link between the two. Also, a custom application specific integrated circuit (ASIC) can be configured to have the functionalities described herein, including the voltage translation function.

Digital processor 510 is programmed to output a logic level (typically 3.3 V or 3.0 V) square wave with a 50% duty cycle at the desired frequency. The desired frequency in this embodiment is 2 kHz. Digital processor 510 has an internal clock that is set to run at a much greater frequency than the desired frequency. The internal clock frequency in this embodiment is 250 MHz. The outputs of digital processor 510 are all 50% duty cycle square waves but with a phase difference between zero and one-half of a period. The phase difference is an integral multiple of the internal clock frequency. As a result, any two outputs can have a time resolution of 250 MHz divided by 2 kHz or 125,000 parts in a full period. For a half-period maximum phase difference, the phase resolution is 1 part in 62,500.

Each of the voltage translators 505, 506-1, 506-2 has two power supply voltage inputs, one for the input logic level and the other for the output logic level. The logic level input supply voltage is the same as the output supply voltage of digital processor 510, in this case 3.3 V or 3.0 V, and the logic level output supply voltage depends on the operational characteristics of LC cells, in this example, 7.07 V. A resistor may be provided in series between the voltage translator output and the control electrode (e.g., column control electrode 305 and row control electrodes 306A-F) to control the voltage transient response during switching, for example, to eliminate ringing due to parasitic inductance.

In operation, digital processor 510 generates digital control signals (e.g., the 50% duty cycle square waves) and supplies them to voltage translators 505, 506-1, 506-2. Voltage translators 505, 506-1, 506-2 translate the voltage level of the digital control signals to produce the control signals for the control electrodes. Voltage translator 505 produces the control signal for column control electrode 305. Voltage translator 506-1 produces the control signal for row control electrodes 306A, 306C, 306D, 306F. Voltage translator 506B produces the control signal for row control electrodes 306B, 306E.

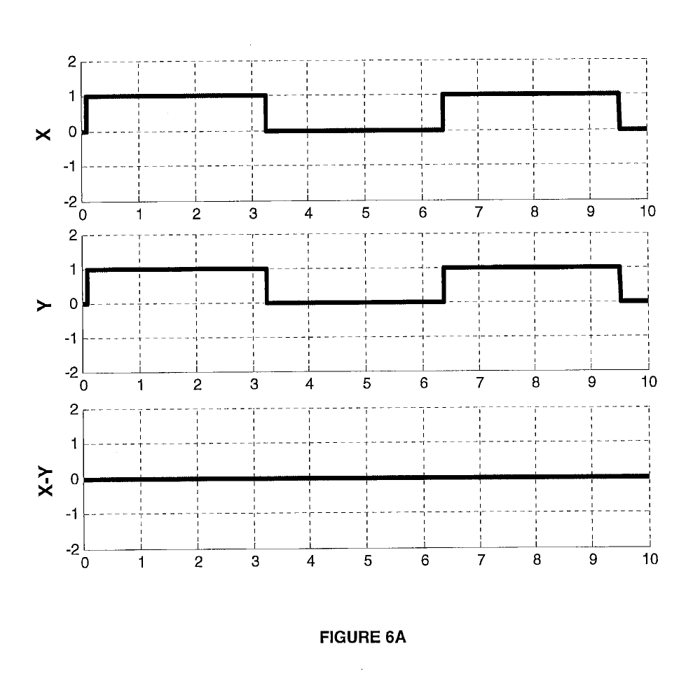

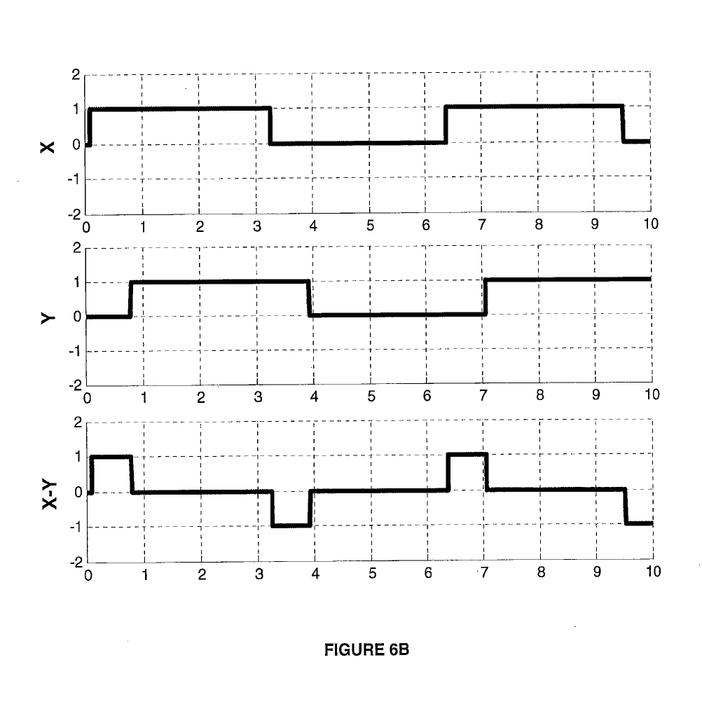

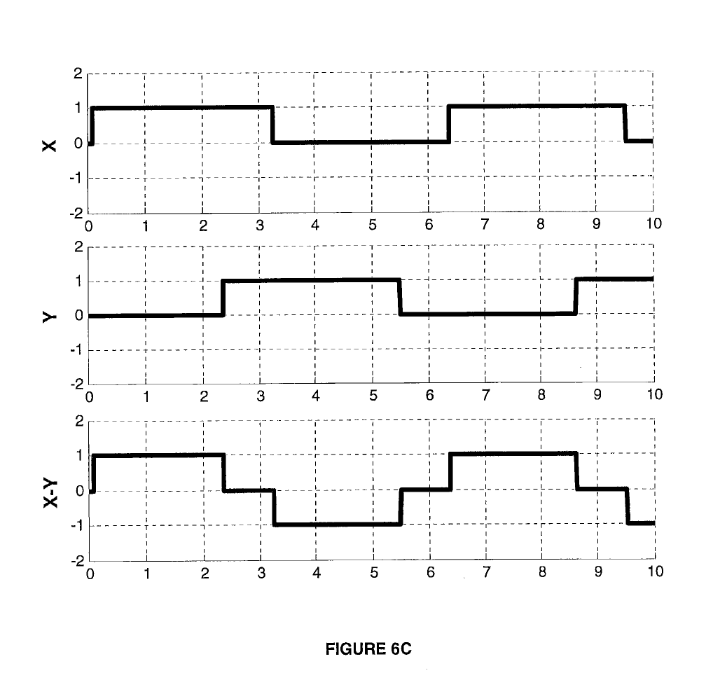

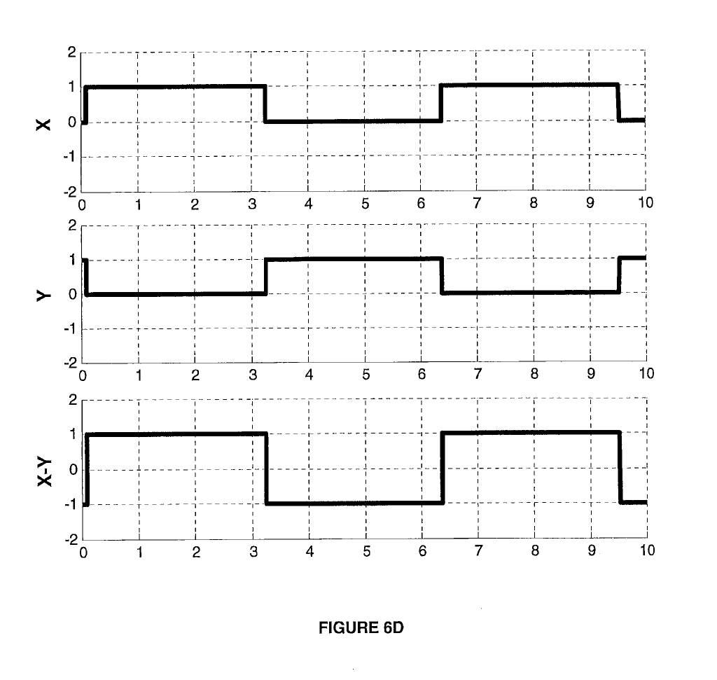

FIGS. 6A-D show representative control signals generated by LC drive unit 390. In these figures, the horizontal axis represents time and the vertical axis is normalized to unity voltage. X and Y represent control signals applied to opposite sides of an LC cell (e.g., column control electrode 305 and one of the row control electrodes 306A-F). The X-Y graph shows the differential voltage across the LC cell.

FIG. 6A shows the same control signal applied to both sides of the LC cell. Thus, as shown in the X-Y graph, the differential voltage across the LC cell is zero. FIG. 6B shows the X and Y control signals differing in phase by one-eighth of a period. In this case, the RMS voltage across the LC cell is 0.5*VDD, where VDD represents logic level output supply voltage of voltage translators 505, 506-1, 506-2. FIG. 6C shows the X and Y control signals differing in phase by three-eighths of a period. In this case, the RMS voltage across the LC cell is 0.866*VDD. As shown in FIG. 6D, when the X and Y control signals differ in phase by one-half of a period, the RMS voltage across the LC cell is 1*VDD.

In one embodiment of the LC drive unit shown in FIG. 5, the Altera EP3C8F256C8, which is an FPGA, is used as digital processor 510 and On Semiconductor MC14504B hex level translator is used as voltage translators 505, 506-1, 506-2. In this embodiment, the phase data for the outputs is stored in registers. If a value of zero is stored as the phase data, the corresponding output signal will have zero phase difference relative to a reference signal. If a value of one is stored as the phase data, the corresponding output signal will have a phase difference one clock cycle relative to a reference signal. Therefore, if the internal clock of digital processor 510 operates at 250 MHz and the frequency of control signals is 2 kHz, a value of 15,625 would be stored to achieve a phase difference of one-eighth period, a value of 31,250 to achieve a phase difference of one-fourth period, and 62,500 to achieve a phase difference of one-half period.

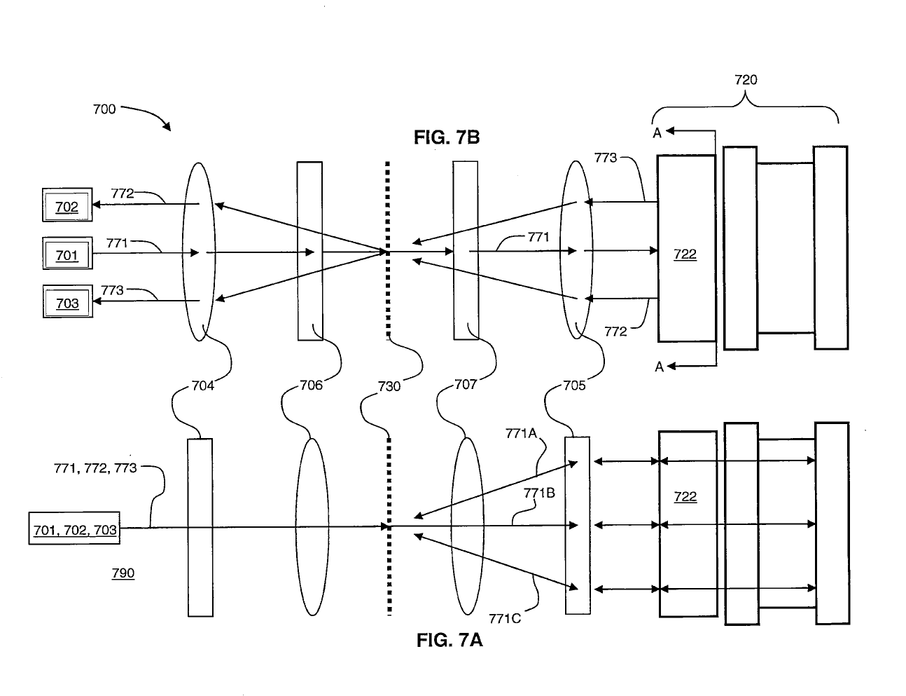

FIG. 7A is a schematic top view of a wavelength selective switch having an LC assembly that is driven in accordance with one or more embodiments of the invention. FIG. 7B is a schematic side view of a wavelength selective switch having an LC assembly that is driven in accordance with one or more embodiments of the invention. WSS 700 can selectively direct each of the wavelength channels of an input light beam to one of two output optical paths. For example, an input light beam containing a plurality of wavelength channels enters through an input fiber and each of the individual wavelength channels may be directed to one of two output fibers.

WSS 700 includes an optical input port 701, optical output ports 702 and 703, beam shaping optics, a diffraction grating 710 and an optical switching assembly 720. WSS 700 may also include additional optics, such as mirrors, focusing lenses, and other steering optics, which have been omitted from FIGS. 7A, 7B for clarity. The beam shaping optics include x-cylindrical lenses 704, 705 and y-cylindrical lenses 706, 707. The components of WSS 700 are mounted on a planar surface 790 that is herein defined as the horizontal plane for purposes of description. In the example described herein, planar surface 790 is substantially parallel to the plane traveled by light beams interacting with WSS 700. Also for purposes of description, the configuration of WSS 700 described herein performs wavelength separation of a wavelength division multiplexed (WDM) signal in the horizontal plane and switching selection, i.e., channel routing, in the vertical plane.

Optical input port 701 optically directs a WDM optical input signal 771 to the WSS 700. Optical input signal 771 includes a plurality of multiplexed wavelength channels and has an arbitrary combination of s- and p-polarization. X-cylindrical lens 704 vertically extends inbound beam 750, and cylindrical lens 716 horizontally extends inbound beam 750. Together, X-cylindrical lens 704 and Y-cylindrical lens 706 shape optical input signal 771 so that the beam is elliptical in cross-section when incident on diffraction grating 710, wherein the major axis of the ellipse is parallel with the horizontal plane. In addition, X-cylindrical lens 704 and Y-cylindrical lens 706 focus optical input signal 771 on diffraction grating 710.

Diffraction grating 710 is a vertically aligned diffraction grating configured to spatially separate, or demultiplex, each wavelength channel of optical input signal 771 by directing each wavelength along a unique optical path. In so doing, diffraction grating 717 forms a plurality of inbound beams, wherein the number of inbound beams corresponds to the number of optical wavelength channels contained in optical input signal 771. In FIG. 7A, diffraction grating 710 is depicted separating optical input signal 771 into three input signals 771A-C. In practice, the number of optical channels contained in input signal 771 may be up to 50 or more. Because the separation of wavelength channels by diffraction grating 710 takes place horizontally in the configuration shown in FIGS. 7A, 7B, spectral resolution is enhanced by widening inbound beam 750 in the horizontal plane, as performed by Y-cylindrical lens 706. Diffraction grating 710 also performs wavelength channel combination, referred to as multiplexing, of output beams 772, 773.

Together, X-cylindrical lens 705 and Y-cylindrical lens 707 columnate optical input signal 771 so that the beam is normally incident to the first element of optical switching assembly 720, i.e., birefringent displacer 301. In addition, X-cylindrical lens 705 and Y-cylindrical lens 707 focus output beams 772, 773 on diffraction grating 710 after the beams exit optical switching assembly 720.

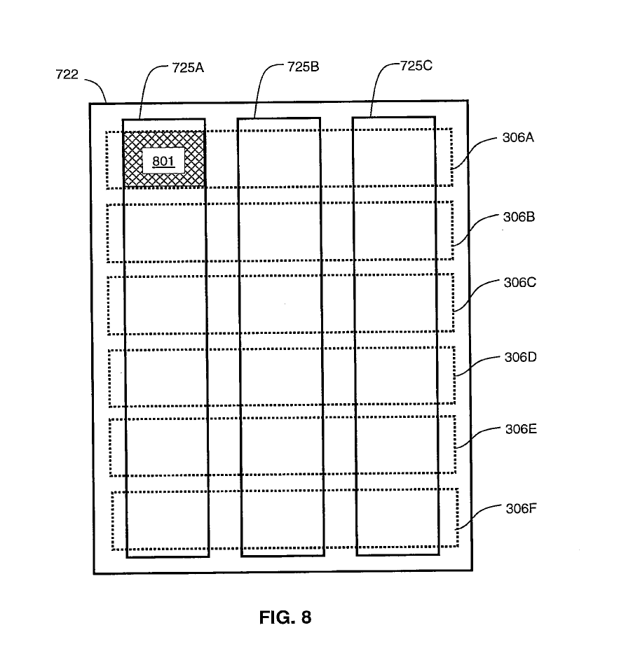

FIG. 8 illustrates a schematic cross-sectional view of an LC beam-polarizing array 722 for processing multiple input light beams, according to an embodiment of the invention. FIG. 8 is taken at section line A-A of LC beam-polarizing array 722, as indicated in FIG. 7B. LC beam-polarizing array 722 includes a plurality of column control electrodes 725A-C and a plurality of row control electrodes 306A-F. Each of column control electrodes 725A-C is substantially similar in configuration to column control electrode 305 in FIG. 3, and corresponds to one of the wavelength channels into which optical input signal 771 is de-multiplexed. To that end, each of column control electrodes 725A-C is positioned appropriately so that the desired wavelength channel is incident on the requisite column electrode. For clarity, column electrodes for only three channels are illustrated in FIG. 8. Column electrode arrays configured for 50 or more wavelength channels are also contemplated. Row control electrodes 306A-F act as common electrodes for all wavelength channels processed by LC beam-polarizing array 722. The pixels of LC beam-polarizing array 722 are defined by the regions between column control electrodes 725A-C and row control electrodes 306A-F. The cross-hatched region in column electrode 725A indicates one such pixel 801 of LC beam-polarizing array 722.

In operation, WSS 700 performs optical routing of a given wavelength channel by conditioning (via LC polarization) and columnly displacing the s- and p-components of the channel in the same manner described above for input beam 371 in optical device 300. Thus, output beam 772, which is columnly displaced below input beam 771 in LC beam-polarizing array 722, includes the wavelength channels selected for output port 702. Similarly, output beam 773, which is columnly displaced above input beam 771 in LC beam-polarizing array 722, includes the wavelength channels selected for output port 703.

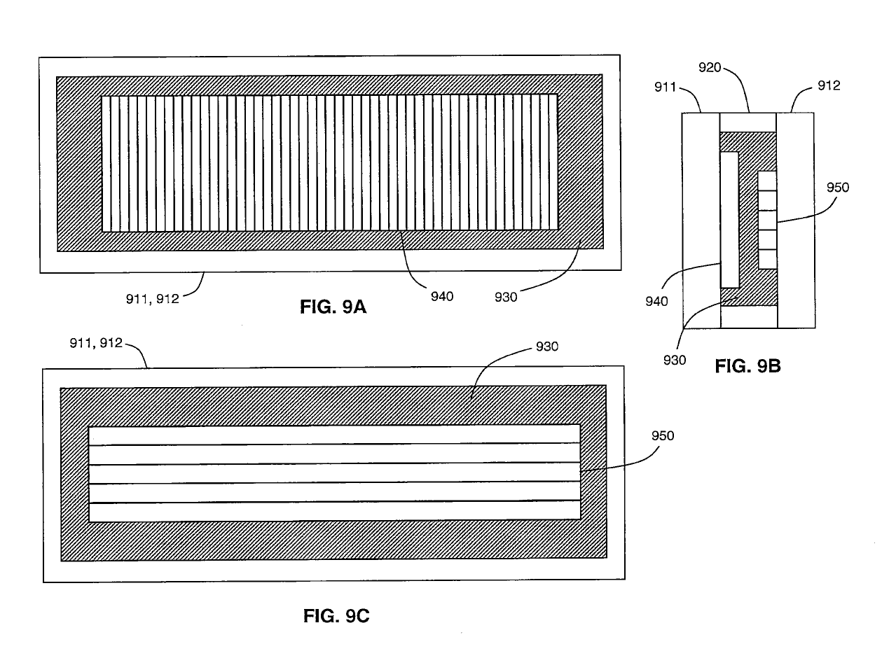

FIGS. 9A-9C are front, side, and rear views of an LC assembly used in an embodiment of a wavelength selective switch having 50 channels. The LC assembly includes a pair of glass substrates 911, 912 that are bonded together with an adhesive material 920 and sandwich an LC material 930, e.g., twisted nematic material. A plurality of column electrodes 940 are formed on one side of LC material 930 and a plurality of row control electrodes 950 are formed on the other side of LC material 930.

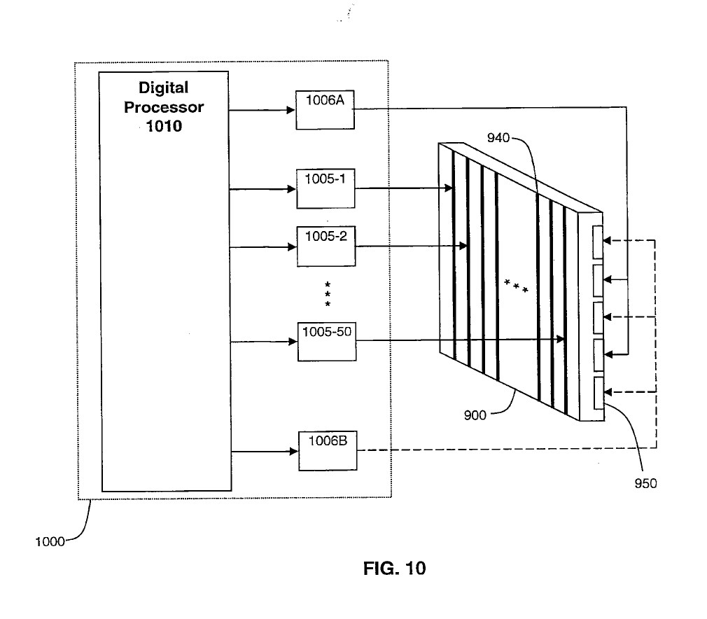

In the embodiment shown in FIGS. 9A-9C, each of column electrodes 940 is independently controlled. Row control electrodes 950 are controlled as two groups. The first group includes the first, third and fifth row control electrodes (counting from top to bottom in FIGS. 9B and 9C) and the second group includes the second and fourth row control electrodes. FIG. 10 is a block diagram of an LC drive unit 1000 used to control the LC assembly of FIGS. 9A and 9B.

LC drive unit 1000 includes a digital processor 1010, voltage translators 1005-1, 1005-2, . . . , 1005-50, each connected to a corresponding column electrode on LC assembly 900, voltage translator 1006-1 connected to a first group of row control electrodes on LC assembly 900 and voltage translator 1006-2 connected to a second group of row control electrodes on LC assembly 900. Digital processor 1010 may be a field programmable gate array (FPGA), a complex programmable logic device (CPLD), a digital signal processor (DSP), or any general or special purpose microprocessor including CISC, RISC and ARM types. Alternatively, an FPGA or CPLD can be combined with a processor with a communication link between the two. Also, a custom application specific integrated circuit (ASIC) can be configured to have the functionalities described herein, including the voltage translation function.

Digital processor 1010 is programmed to output a logic level (typically 3.3 V or 3.0 V) square wave with a 50% duty cycle at the desired frequency. The desired frequency in this embodiment is 2 kHz. Digital processor 1010 has an internal clock that is set to run at a much greater frequency than the desired frequency. The internal clock frequency in this embodiment is 250 MHz. The outputs of digital processor 1010 are all 50% duty cycle square waves but with a phase difference between zero and one-half of a period. The phase difference is an integral multiple of the internal clock frequency. As a result, any two outputs can have a time resolution of 250 MHz divided by 2 kHz or 125,000 parts in a full period. For a half-period maximum phase difference, the phase resolution is 1 part in 62,500.

Each of the voltage translators 1005-1, 1005-2, . . . , 1005-50, 1006-1, 1006-2 has two power supply voltage inputs, one for the input logic level and the other for the output logic level. The logic level input supply voltage is the same as the output supply voltage of digital processor 1010, in this case 3.3 V or 3.0 V, and the logic level output supply voltage depends on the operational characteristics of LC cells, in this example, 7.07 V. A resistor may be provided in series between the voltage translator output and the control electrode to control the voltage transient response during switching, for example, to eliminate ringing due to parasitic inductance. In operation, digital processor 1010 generates digital control signals (e.g., the 50% duty cycle square waves) and supplies them to the voltage translators. The voltage translators translate the voltage level of the digital control signals to produce the control signals for the control electrodes.

In one embodiment of the LC drive unit shown in FIG. 10, the Altera EP3C8F256C8 is used as digital processor 1010 and On Semiconductor MC14504B hex level translator is used as the voltage translators. In this embodiment, the phase data for the outputs is stored in registers. If a value of zero is stored as the phase data, the corresponding output signal will have zero phase difference relative to a reference signal. If a value of one is stored as the phase data, the corresponding output signal will have a phase difference one clock cycle relative to a reference signal. Therefore, if the internal clock of digital processor 1010 operates at 250 MHz and the frequency of control signals is 2 kHz, a value of 15,625 would be stored to achieve a phase difference of one-eighth period, a value of 31,250 to achieve a phase difference of one-fourth period, and 62,500 to achieve a phase difference of one-half period.

The digital LC driving technique described herein may be applied to optical devices of other types. For example, it may be used to vary the index of refraction of smectic LC cells in tunable filters.

While the foregoing is directed to embodiments of the present invention, other and further embodiments of the invention may be devised without departing from the basic scope thereof, and the scope thereof is determined by the claims that follow.

I claim:

1. An optical device comprising:
a liquid crystal (LC) assembly disposed in optical paths of input beam components, the LC assembly having a plurality of LC cells each arranged between a pair of opposing control electrodes; and
a driving mechanism for the control electrodes for generating a first control signal to be applied to the first of the opposing control electrodes from a first digital signal and a second control signal to be applied to the second of the opposing control electrodes from a second digital signal, wherein the first and second digital signals have the same period but differ in phase by up to one-half period.

2. The optical device according to claim 1, wherein the driving mechanism includes a first voltage translator for producing the first control signal from the first digital signal and a second voltage translator for producing the second control signal from the second digital signal.

3. The optical device according to claim 2, wherein the first and second voltage translators are configured to have the same output supply voltage level.

4. The optical device according to claim 1, wherein the control electrodes include a plurality of column electrodes and at least one row electrode, and the LC cells are arranged between said column electrodes and said at least one row electrode.

5. The optical device according to claim 4, wherein the driving mechanism is configured to apply the first control signal to said at least one row electrode and the second control signal to one of said column electrodes.

6. The optical device according to claim 1, wherein the driving mechanism includes a digital processor for generating the first and second digital signals and voltage translators for generating the first and second control signals from the first and second digital signals.

7. The optical device according to claim 6, wherein the digital processor is a field programmable gate array (FPGA) having an internal clock that runs at a frequency that is multiple orders of magnitude greater than the frequency of the first and second digital signals.

8. An optical device comprising:
a liquid crystal (LC) assembly disposed in optical paths of input beam components, the LC assembly having a plurality of column electrodes, at least one row electrode, and LC cells arranged between said column electrodes and said at least one row electrode;
a digital processor for generating digital control signals;
a first voltage translator electrically connected to said at least one row electrode for generating a control signal to be applied to said at least one row electrode from a first digital control signal generated by the digital processor; and
a second voltage translator electrically connected to one of said column electrodes for generating a control signal to be applied to said one of said column electrodes from a second digital control signal generated by the digital processor.

9. The optical device according to claim 8, wherein the first and second digital control signals have the same period but differ in phase by up to one-half period.

10. The optical device according to claim 8, further comprising a third voltage translator electrically connected to another one of said column electrodes for generating a control signal to be applied to said another one of said column electrodes from a third digital control signal generated by the digital processor.

11. The optical device according to claim 10, wherein the first and third digital control signals have the same period but differ in phase by up to one-half period.

12. The optical device according to claim 10, wherein the first, second and third voltage translators are configured to have the same output supply voltage level.

13. The optical device according to claim 8, wherein the digital processor is a field programmable gate array (FPGA) having an internal clock that runs at a frequency that is multiple orders of magnitude greater than the frequency of the digital control signals.

14. An optical device comprising:
a first birefringent displacer disposed in an optical path of an input beam for producing input beam components having first and second polarization states, the first and second polarization states being orthogonal with respect to each other;
a liquid crystal (LC) assembly disposed in optical paths of the input beam components for conditioning the polarization states of the input beam components, the LC assembly having control electrodes and a drive unit that generates control signals for the control electrodes from digital signals that have the same period but differ in phase by up to one-half period; and
a second birefringent displacer for directing the input beam components based on their polarization states as conditioned by the LC assembly.

15. The optical device according to claim 14, wherein the control electrodes include a plurality of column electrodes, a first row electrode and a second row electrode, and LC cells are defined between the column electrodes and the row electrodes.

16. The optical device according to claim 15, wherein the driving mechanism includes a first voltage translator for producing a control signal for the first row electrode from a first one of the digital signals, a second voltage translator for producing a control signal for the second row electrode from a second one of the digital signals, and a third voltage translator for producing a control signal for one of the column electrodes from a third one of the digital signals.

17. The optical device according to claim 16, wherein the driving mechanism includes a digital processor for generating the digital signals.

18. The optical device according to claim 17, wherein the digital processor is a field programmable gate array (FPGA) having an internal clock that runs at a frequency that is multiple orders of magnitude greater than the frequency of the digital signals.

19. The optical device according to claim 15, wherein the first birefringent displacer and the LC assembly are positioned relative one another so that the input beam component having the first polarization state passes through an LC cell positioned between one of the column electrodes and the first row electrode and the input beam component having the second polarization state passes through an LC cell positioned between one of the column electrodes and the second row electrode.

20. The optical device according to claim 19, further comprising:
a diffraction grating disposed in the optical path of the input beam for separating the input beam into multiple wavelengths before the input beam passes through the first birefringent displacer; and
a reflective element disposed in the optical paths of multiple output beams produced by the second birefringent displacer so that the multiple output beams are redirected back through the second birefringent displacer, the LC assembly, the first birefringent displacer, and the diffraction grating.
